(19) United States
(12) Patent Application Publication
(10) Pub. No.: US 2002/0049705 A1
(43) Pub. Date: Apr. 25, 2002

(54) Method for creating content oriented databases and content files

(75) Inventors: Irit Haviv-Segal, Tel-Aviv (IL); Amir Viner, Glazar (IL)

Correspondence Address: DR. MARK FRIEDMAN LTD., c/o BILL POLKINGHORN - DISCOVERY DISPATCH, 9003 FLORIN WAY, UPPER MALBORO, MD, 20772, US

(73) Assignee: E-BASE LTD.

(21) Appl. No.: 09/845,196

(22) Filed: May 1, 2001

Related U.S. Application Data
(60) Provisional application No. 60/199,008, filed on Apr. 19, 2000.
(60) Provisional application No. 60/226,694, filed on Aug. 22, 2000.

(30) Foreign Application Priority Data
Apr. 19, 2001 (IL) IL01/00364

(51) Int. Cl. G06F 7/00

(52) U.S. Cl. 707/1

(57) ABSTRACT

A system and method for enhancing both the retrieval and the acquisition of knowledge from electronic databases, incorporating content expertise, linguistics, and search technology. Unlike the current content-neutral technologies, the new invention presents a platform for an automated construction of content-oriented databases, where knowledge is organized according to content, rather than according to its initial sources. The invention includes an innovative platform for an automated reorganization of knowledge, where the system automatically filters, slices, maps and links fragments of the initial files onto a modular structure of knowledge. Eventually, the system virtually substitutes the initial source files by content-files, where all of the relevant fragments from all relevant source-files are automatically integrated and hung onto the relevant node of a modular structure of knowledge. From the user's viewpoint, the new invention offers to substitute the concept of “search” by the concept of “mapping,” such that instead of running Boolean searches, the user is guided to the relevant pieces of information via a map of links, which reflects the modular structure of the relevant field of knowledge. Because each node is linked to a content-file, the user is further guided to relevant fragments of information, with no need to engage in time consuming costly search-processes.

### FIELD AND BACKGROUND OF THE INVENTION

### BACKGROUND OF THE INVENTION

1. Field of the Invention

The present invention offers a new approach to knowledge management and the reorganization of professional electronic databases.

2. Description of the Related Art

The Internet is changing the way we acquire knowledge. Traditional ways of knowledge acquisition, such as libraries, archives, and professional databases, are gradually becoming replaced by online information research. This new medium presents its own challenges, and has lead to the development of environments that supports the transformation of information to knowledge. With the overflow of information, systems are being developed which attempt to enable surfers to retrieve only relevant pieces of information in just a few clicks.

Secondly, online researching trains the human brain to acquire knowledge in fragments, rather than in comprehensive texts. Accordingly, there have been developments of systems which can extract and filter relevant content fragments from full-text-sources, in order to provide faster access to relevant data, in a personalized way.

Finally, finding information on the Internet does not only exceed human abilities to acquire knowledge, but further challenges content providers and system managers: with the overflow of information, it becomes practically impossible to manually organize knowledge. Even the most sophisticated software means for knowledge management do not answer the current needs, in the case where the software application requires intensive human labor. In a world where almost all of human knowledge is accumulated within one huge source, any novel concept of knowledge management may be worthless unless it lends itself to automation. It is this latter requirement which poses the strongest challenge, because the computer generally lacks the human abilities to determine meaning and to engage in deliberate decision making, whereas, these abilities appear to be necessary factors in any processing of knowledge management.

### Related Patents

U.S. Pat. No. 692,181 describes a system and method for generating reports from a computer database. This invention enables the user to make decisions, without requiring the user to understand or interpret data itself. This invention includes a method of creating data types and data relationships within a database, for generating reports for users, that includes the steps of: organizing the data within the database into columns of tables, providing a computer coupled to the database that executes an application program that generates the report, recording a business concept by the application program, recording an attribute associated with the business concept by the application program, displaying a list of the columns of tables in the database by the computer, recording a mapping of the attribute to one of the columns in the list, displaying a list of business indicators by the computer, recording a mapping of one of the business indicators to the column, joining the attribute table with the business indicator table so that the application program can use the additional table to create the report.

### Limitations of U.S. Pat. No. 692,181

1. This system does not extract the important information from the different sources but rather gathers them together according to a specific terminology inserted by the user.

2. This reorganization is driven by the user and not by the system according to a specific field of knowledge. This means that if the user is not familiar with the specific relevant terminology, the machine would not be able to create such a report.

3. The system has to analyze the database every time the user activates it over and over again instead of reorganizing the whole database only once according to a specific field of knowledge.

U.S. Pat. No. 5,768,578 describes an improved information retrieval system user interface for retrieving information from a plurality of sources and for storing information source descriptions in a knowledge base. The user interface includes a hypertext browser and a knowledge base browser/editor. The hypertext browser allows a user to browse an unstructured information space through the use of interactive hypertext links. The knowledge base browser/editor displays a directed graph representing a generalization taxonomy of the knowledge base, with the nodes representing concepts and edges representing relationships between concepts. The system allows users to store information source descriptions in the knowledge base via graphical pointing means. By dragging an iconic representation of an information source from the hypertext browser to a node in the directed graph, the system will store an information source description object in the knowledge base. The knowledge base browser/editor is also used to browse the information source descriptions previously stored in the knowledge base. The result of such browsing is an interactive list of information source descriptions which may be used to retrieve documents into the hypertext browser. The system also allows for querying a structured information source and using query results to focus the hypertext browser on the most relevant unstructured data sources.

### Limitations of U.S. Pat. No. 5,768,578

1. The user has to manually attach every source to the correct node in the tree. This may lead to incorrect attachments, which eventually might create disorder and chaos in the systems database.

2. This system does not extract the important information from the different sources but rather gathers them together as full texts.

3. The ability of the user to remember the whole structure of the tree by heart is limited thus limiting his\hers ability to remember all of the possible nodes in which to attach a source.

### Related Systems, Methods and Technologies

There are four different kinds of players in the market today. The new invention is aimed at integrating all four of them creating a combined solution. The four markets are:

### Professional Content Sites

Forrester (www.forrester.com), which is a leader in providing market research in various fields, has defined content sites as those that use information and entertainment to attract or retain an audience, in order to sell advertising or subscriptions. The market's leading players are:

Legal information sites: Lexis (www.Lexis.com), Westlaw (www.westlaw.com), Findlaw (www.Findlaw.com), CourtTV (www.courttv.com), etc.

Financial information sites: www.thestreet.com www.businesswire.com, www.redherring.com, www.globalnetfinancial.com, www.cnnFn.com etc.

Technology sites: Cnet (www.cnet.com), Techweb (www.techweb.com), www.edgeReview.com, www.msnbc.com etc.

The Professional Content Sites, such as those listed above, supply content that is not organized intuitively and cannot be accessed efficiently by a non-expert. The overwhelming amount of information stored in the professional databases can be accessed by a combination of search phrases or by a categorical index. Only a professional expert can articulate the accurate search phrase or find the route that leads from the homepage down to the relevant topic. FIG. 1 shows an example of a search request using a content specific database from Lexis (www.Lexis.com). Lexis is an example of a popular existing search tool that uses professional on-line databases. Common deficiencies with such tools, however, include a need for specialist knowledge of the subject being searched, provision of results in long menus, a need for strong familiarity with subject content, a need for high level of user expertise, a requirement for re-definitions during searches, and a need for knowledge of correct search phrases and relevant dates.

Knowledge management platforms: The topic of knowledge management encompasses a myriad of concepts and applications having to do with the purposeful generation, diffusion, and application of knowledge towards fulfilling an organization's objectives. The market's leading players are: www.Microsoft.com, Lotus notes (http://www.lotus.com/home.nsf/welcome/km), www.kmsoftware.com, www.Adexperts.com, www.inova.com www.equifax.com.

Current knowledge management platforms, such as those listed above, are intended to supply users with an integrated platform to organize their database in order to efficiently extract information. No known system represents an integrated solution that combines the technology with the specific terminology of a professional field. Therefore no system can slice down actual content from a textual source, and automatically extract relevant pieces of information.

### Smart Search Engines

These engines are programs that searches documents for specified keywords and return a list of the documents where the keywords were found. Although search engine is really a general class of programs, the term is often used to specifically describe systems like Alta Vista (www.altavista.com) and Excite (www.excite.com) that enable users to search for documents on the World Wide Web and USENET newsgroups.

Typically, a search engine works by sending out a spider (an intelligent software agent, or program, that searches for information on the World Wide Web by locating new documents and new sites by following hypertext links from server to server) to fetch as many documents as possible. Another program, called an indexer, then reads these documents and creates an index based on the words or other contents contained in each document. Each search engine uses a proprietary algorithm to create its indices such that, ideally, only meaningful results are returned for each query. The market's leading players are: Zapper (www.zapper.com), Copernic (www.copernic.com), Google (www.google.com) and Alta Vista (www.altavista.com). These search engines and other smart engines are constantly improving their ability to index online sites and utilize sophisticated spiders.

Google, for example highlights search phrases within the search results page.

Zapper can “understand” the contextual environment of the terms from within the paragraph they were invoked from.

Copernic uses leading engines to aggregate all of their search results on one screen.

In addition, there are a growing numbers of online sites that are published daily. The combination of these two factors creates an overwhelming amount of web pages that are retrieved by the search engines upon the user's search request.

### Content Aggregation Tools

These tools refer to collecting content from disparate sources and combining it in meaningful ways. The market's leading players are: Octopus (www.octopus.com), www.yodlee.com, www.onepage.com, www.Correlate.com www.thebrain.com

These tools, however, do not prevent information overflows and essentially rely on the findings of the smart search engines.

Octopus, for example, clips relevant data and content from various Web sites and pulls it all together in one dynamic browser page, called a “View.”

Correlate enables a user to create visual Knowledge Maps by dragging & dropping MS-Office documents, emails, web content and other data.

The above tools, however, significantly limit user research, owing in general to several setbacks. The first setback is that navigation or information research is generally based on a links that are scattered within web sites. The main trigger for clicking a link is to advance to a different location that might enfold another aspect of the desired information. This kind of navigation is completely unstructured and relies heavily on intuition and luck. The second setback is owing to the employment of search engines that enable the user to articulate a desired phrase and then check sequentially each one of the search results. Users are usually overwhelmed with an enormous numbers of results following a query, which they must filter and screen manually in order to retrieve the required pieces of information. This procedure often leaves the user empty handed, frustrated and exhausted. With the vast expansion of on-line sources, users are often overwhelmed with an enormous number of files, which they must filter and screen manually in order to retrieve the required pieces of information. Despite the exploding quantity of information, the revolutionary capabilities of computers have hardly been utilized to improve the process of acquiring knowledge. Instead of dealing with information fragments (within textual sources) that capture the ideas of the human thought, existing systems settle for uploading the various sources of information, as is, onto the databases. As such, current search methods are generally content neutral and passive. Existing search engines are mechanical in their nature. Because the machine does not “understand” meaning, it can only provide the user with Boolean search methods, which retrieve sources according to a specific combination of words. Nevertheless, the Boolean search rarely provides the user with the requisite results: many of the retrieved sources would usually be irrelevant, whereas, relevant pieces of information may be missed, due to their use of alternative terminologies and significantly limited logic.

Today's information technology is constantly creating standards and regulations to every technological issue be it G3, Bluetooth, XML etc. Based on this background the absence of such standards in search procedures is so apparent. The lack of standardization is the basis to an evolving chaos in the way content providers are organizing their databases. Online users that need to retrieve information from many different sites are forced to learn by trial and error the unique structure and features of every site. This process of accessing information from a constantly growing variety of formats is time-consuming and inefficient. Users of Boolean search engines typically require familiarity with the professional terminology of the required field of knowledge. Otherwise, the search results will not be efficient and comprehensive. Thus, only experts are capable of conducting effective searches using the search engines. However, current search methods do not provide users with any automated tool for tracking and marketing the expert-searches that captures the experts' knowledge. Rather, each user has to conduct his or her own limited search, whereas, the sole possibilities to save and utilize an expert's abilities are manual.

Current search systems generally provide data responses comprising long lists of sources, which need to be screened in order to find the relevant ones. Usually, the number of relevant sources is only a fraction of the initial number of search results. Furthermore the user usually seeks only a refined collection of fragments from those textual sources. Naturally, the user would want to save the fragments that he or she retrieved from the search process. The current systems do not provide the user with any automated system for saving the search results. To construct such a system, a user inevitably has to manually “cut and paste” the search results to a word-processor file. Even when such a user has engaged in a manual “cut and paste” process for saving his/her search results, the added value of such a process would usually be limited. In a world where sources are quickly inter-changing and where texts swiftly become outdated as they are overtaken by newer ones, there is a constant need to update such a file. Today there is no known automated system that deals with this problem.

Because typical software tools are mechanical, it is the user who has to combine the tools together in order to enhance his or her professional activities. The user needs to transfer from one software, or Web site, to another. For example, while the user retrieves the on-line information by using the Internet browser (i.e., in HTML files), s/he would usually prefer to save the search results in the word processor format (e.g., in Word files). To the extent that the user strives to conduct some empirical study, or, prepare a presentation, s/he would further need to transfer to a spreadsheet or presentation software etc. However, the manual shift from one software means to another is time consuming, and may well limit the user's abilities and efficiency.

Current content-neutral databases generally make only a limited use of links and hyper-links, as the links are manually placed on the HTML (or, other) files. As long as links are added to the texts, the system cannot achieve or trace any systematic phenomena within the texts. It cannot trace recurrence of similar links, nor construct any systematic structure of the links. Instead, both the use of the texts and the links themselves remain static and do not avail themselves to dynamic applications. The implementation of links also involves intensive manual labor and massive quality assurance procedures.

Finally, the current user's interfaces are typically tedious and troublesome. The main reason for this is the complex mode of presentation that forces the user to navigate in an unstructured set of categories. This inevitably deprives him/her from gaining access to the site's knowledge. The interfaces usually facilitate a search engine for the perplexed user. These search engines again overwhelm the user instead of simplifying and understanding his/hers basic intentions.

It should be noted that while there may exist some solutions to some of the following setbacks, until now, no known comprehensive efforts have been made to conceptually alter the basic structure of current information-systems.

There is thus a widely recognized need for, and it would be highly advantageous to have, a comprehensive solution that redefines knowledge according to a content specific corpus, reorganizes fragments of information into a modular structure and wraps all of these components within a user-sensitive interface. There is a further need to break down the text into fragments and aggregate them according to the different ideas they convey. Furthermore, there is a need for a system that can enable a user to define new terms and detect and manage relationships between terms, without requiring the user to have knowledge of underlying data structures or of the SQL programming language. There is also a great need for a system that organizes professional databases and captures the ability of a professional expert, to enable non-professional researchers to access relevant textual sources. It would be further advantageous to have a system that can integrate information from various sources and media types, and consolidate the different media types on one screen, in the form of a knowledge tree.

The present invention solves many of the above-mentioned problems, and enables the execution of many of the above-mentioned limitations. This is achieved by providing a user-friendly platform for an automated construction of content-oriented databases, where knowledge is organized according to content, rather than according to its initial sources. The invention includes an innovative platform for an automated reorganization of knowledge, where the system automatically filters, slices, maps and links fragments of the initial files onto a modular structure of knowledge. Furthermore, the present invention organizes knowledge in a context driven way, so that it may be integrated within the corpus of any different professional field. In addition, the present invention organizes only relevant paragraphs from different textual sources, according to sophisticated linguistic rules. This innovative procedure dramatically improves the quality and relevance of the paragraphs that are retrieved and decreases the initial amount of text the user had to go through. The present invention offers substantial benefits over the traditional keyword based search procedures.

### SUMMARY OF THE INVENTION

According to the present invention there is provided a system and method for enhancing both the retrieval and the acquisition of knowledge from electronic databases, incorporating content expertise, linguistics, and search technology. Unlike the current content-neutral technologies, the new invention presents a platform for an automated construction of content-oriented databases, where knowledge is organized according to content, rather than according to its initial sources. The invention includes an innovative platform for an automated reorganization of knowledge, where the system automatically filters, slices, maps and links fragments of the initial files onto a modular structure of knowledge. Eventually, the system virtually substitutes the initial source files by content-files, where all of the relevant fragments from all relevant source-files are automatically integrated and hung onto the relevant node of a modular structure of knowledge. From the user's viewpoint, the new invention offers to substitute the concept of “search” by the concept of “mapping,” such that instead of running Boolean searches, the user is guided to the relevant pieces of information via a map of links, which reflects the modular structure of the relevant field of knowledge. Because each node is linked to a content-file, the user is further guided to relevant fragments of information, with no need to engage in time consuming costly search-processes.

In particular, the new platform presents a novel integration of the following new concepts:

1. Let's go backwards—While in current databases, the user proceeds from huge databases to concise pieces of information, the present invention guides the user from concise knowledge to more elaborate information.

2. A modular structure of knowledge (forms the basis of the database)—Unlike the content-neutral technological platforms for knowledge management, the present invention reorganizes the database onto a modular structure that reflects knowledge. The modular structure of knowledge contains all the ideas in a specific field of knowledge and is arranged according to a hierarchy where the top nodes are more general and the lower ones are more specific. This structure is initially created by an expert in a particular field, according to industry standards.

3. Content files—Instead of constructing the database according to source-files, the present invention creates content-files. The content-file is a “multiple windows” window which integrates all of the relevant fragments of the source-files within one virtual file. Accordingly, all the paragraphs in the content file deal with the same idea, and are linked back to initial source file.

4. The database is content-oriented—Instead of the current content-neutral construction of databases, the present invention reconstructs a content-oriented database, where the information fragments are allocated according to the modular structure of knowledge.

5. The database is made up of links—While in current knowledge tools, the textual sources are generally part of the database, the database of the present invention contains only the links to textual sources. This feature enables the database to be light in size and allow the saving of CPU process time.

6. Virtual retrieval—Instead of overloading the system with real time processes for each search query, the present invention achieves virtual retrieval of knowledge. This is achieved by doing “pre-analysis” of texts before they are uploaded to the system. As the user activates a node, the system just has to retrieve all the relevant paragraphs that are allocated to the nodes using pointers. This procedure creates a virtual content file that is instantly retrieved and is constantly updated.

7. An automated reorganization of knowledge—While in current platforms, it is the user who manually organizes the materials according to content, the present invention enables an automated process that includes: filtering and mapping of fragments of knowledge onto the modular structure. The invention further enables the automatic creation of an objective modular structure of knowledge that is based on the structure that was found in relevant sources.

8. Fragmental module of knowledge—While current search engines flood the user with “full-text” sources; the present invention facilitates access to relevant fragments from within relevant files dealing with the relevant search term.

9. The user's interface—Unlike the current complex user's interfaces, the present invention provides an innovative integration of three modes of knowledge presentation on one screen: a modular structure of knowledge, content-files, and visual presentations.

An additional embodiment of the present invention enables integration of the present invention within old information searching formats, such that the searcher, when using conventional search tools, is instantly directed to the relevant content file.

According to a further preferred embodiment of the present invention, a solution is provided for researchers, wherein prior classifications of experts in the field are utilized, in order to enable professional-level searches by non-experts.

A further embodiment of the present invention is an application for content providers, enabling automated ideas aggregation, fragmentation and organization.

A further embodiment of the present invention is an application for enterprise information portals, wherein personal and public content is integrated into one knowledge base, such that a personalized enterprise's portal is created that replaces the worker's desktop, and allows access to the enterprise and personal knowledge, online and offline.

### BRIEF DESCRIPTION OF THE DRAWINGS

The invention is herein described, by way of example only, with reference to the accompanying drawings, wherein:

FIG. 1 shows an example of a current search method using a content specific database.

FIG. 2 clarifies the structure and role of the outlines, as seen in a content file, according to the present invention.

FIG. 3 illustrates a user navigation session, or the process whereby the user navigates through various outlines, until arriving at the desired content file.

FIG. 4 illustrates a multiple windows window according to the present invention.

FIGS. 5A and 5B illustrate the system architecture and workflow, according to the present invention.

FIG. 6 illustrates a visual presentation of a node and idea it conveys.

FIG. 7 illustrates examples of the table structure within the present invention.

FIGS. 8.1-8.4 demonstrate the filtering and mapping procedures upon one modular structure of knowledge.

FIG. 9 summarizes the novel elements in the new platform of the present invention.

FIG. 10 describes the novelties in the various system elements.

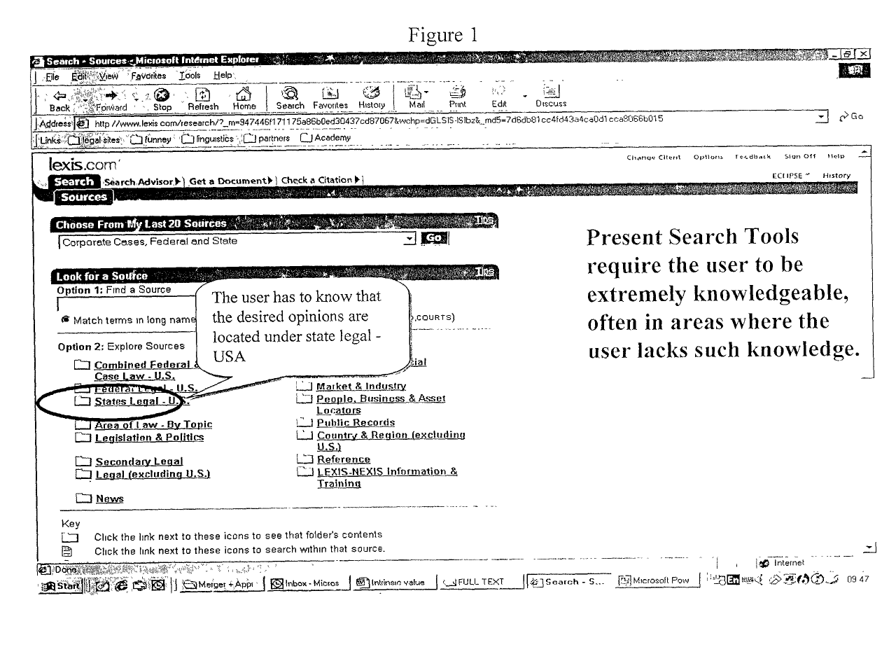

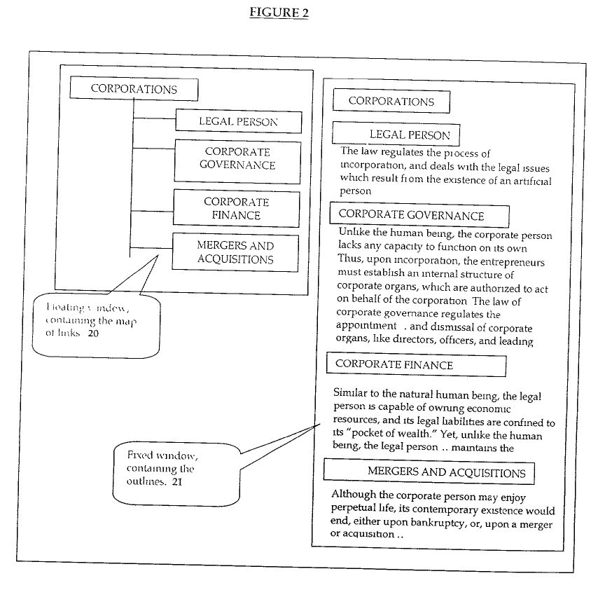

### DESCRIPTION OF THE PREFERRED EMBODIMENT

The present invention relates to a system and method for enhancing both the retrieval and the acquisition of knowledge from electronic databases, incorporating content expertise, linguistics, and search technology.

Specifically, the present invention presents a platform for an automated construction of content-oriented databases, where knowledge is organized according to content, rather than according to its initial sources. The invention includes an innovative platform for an automated reorganization of knowledge, where the system automatically filters, slices, maps and links fragments of the initial files onto a modular structure of knowledge.

The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

The principles and operation of a system and a method according to the present invention may be better understood with reference to the following descriptions and the accompanying drawings, it being understood that these drawings are given for illustrative purposes only and are not meant to be limiting, wherein:

The present invention provides for an innovative knowledge management application, according to the following features:

After an electronic database is organized according to the concept and application of the present invention, a user is able to retrieve the relevant pieces of information in just a few clicks. The system does not settle for guiding the user to the relevant files, but further extracts the relevant fragments from within each source-file. All fragments that are relevant to one specified subject are integrated within one virtual content-file. Most importantly, the new concept is designed in a way that makes automation of knowledge management possible. Accordingly, the present invention presents a system for knowledge management that automatically filters, maps and retrieves fragments of information according to the user's needs.

Out of the information overflow and the emerging chaos on the web, arises a vital need to map textual fragments according to their context and meaning. The present invention fosters the automated attachment of all relevant paragraphs from various relevant sources to a modular structure of knowledge. This “modular structure” refers to a hierarchy-based index that covers all the ideas in a content specific field of knowledge. The structure is built so that the upper nodes (which may be describe as subjects or information categories) are more general and the lower ones convey specific ideas. By doing this, the invention achieves intuitive access to concise content. This new format further overcomes the setbacks of current navigation methods, as described above, by automatically mapping databases and guiding the user in a tailored path to concise content within just a few clicks.

The present inventions' innovative approach to knowledge is content-oriented, rather than source-oriented. Instead of overwhelming the user with huge amounts of “full text sources”, as a result of a search process undertaken, the present invention supplies concise content with an option to go back to the full text if needed. In other words, instead of making the user go through a collection of “search results”, the user is provided with a smart collection of paragraphs, or actual fragments of content, that convey the solution to a desired question. The desired result of a search is seen as a combination of different angles that explain the same issue. Finally if the user chooses to elaborate on a specific angle, the platform can facilitate a simple connection back to the full text. The present invention thereby facilitates direct access to paragraphs rather than files.

Prior art tools for information research typically provide access to a wide information base, content-neutral search- engines, and arbitrary categorical organization of the database. This in turn requires of the user to run the content-dependent searches, overview the files detected by the search-engine, filter, screen, map and patch fragments of information manually from the initial “full text” sources, and digest the relevant pieces of information. In contrast to this, the present invention automatically filters, slices, maps and links fragments of every file onto a modular structure of knowledge; dynamically creates a modular structure to guide the user to the desired concise content; virtually creates content files that integrate all of the relevant fragments of the relevant source-files within one editable virtual file; and interacts with the user in order to deliver a comprehensive tailored solution on one screen, using three complementary cognitive modes of presentation. Consequently, according to the present invention, a user is guided through the platform's modular structure and receives the relevant pieces of information that reflect knowledge, within just a few clicks. The user can optionally jump to the “full text” mode of presentation that is linked to every fragment; and can create and save his\her own personal modular structure for a research project.

The present invention is attuned to the needs of users to define independently the exact search phrase. The present invention provides a renewed concept of a “search engine” that includes an interactive interface that is responsive to the user's requests. Upon the search activation, the system of the present invention digests the various meanings that emerge from the search phrase. This means that the system can locate the various routes that end with a node that contains the search phrase. The user is then invited to choose among several different contexts that might match his/her specific point of reference. The user is then transferred to the relevant node in the modular structure and is presented with a content file that deals with the desired search term within the correct contextual reference. The present invention thereby delivers an interactive interface that is responsive to the user's requests and redefines the traditional “search engine”.

The present invention allows the user a simple yet highly effective way of gathering information from a substantial quantity of electronic sources. Thus, the system of the present invention facilitates the user's access to the relevant pieces of information, and to concentrate the concise content on one computer screen.

The interface is currently designed with ASP technologies using compiled components (COM). The interface is currently designed using Microsoft's windows DNA concept. All access to the database is achieved by using pointers, without the need to scan the whole database. For this reason, the results appear on the user screen substantially faster than those attained using conventional processing of search queries. The user can navigate in the modular structure using a set of links. The links direct the user to the required node. Once the user reaches this node, all the paragraphs that appear in the table are virtually presented, meaning that the actual content from the relevant paragraphs are presented, extracted from their actual sources. A click on one of the paragraphs connects the user to the relevant source in the “source table”.

Unlike the current content-neutral technological platforms for knowledge management, the present invention reorganizes the database onto a modular structure that reflects knowledge. A user, for example, begins by following a map of links, presented on a floating window. The tour through the links does not require any expertise, as the user is guided from more general subjects to the more detailed ones. The map of links mirrors the modular structure of the knowledge base, and is presented within a “knowledge tree.” A “knowledge tree” refers to the directory structure that is hierarchical, reflecting at one time potentially multiple information options on multiple levels.

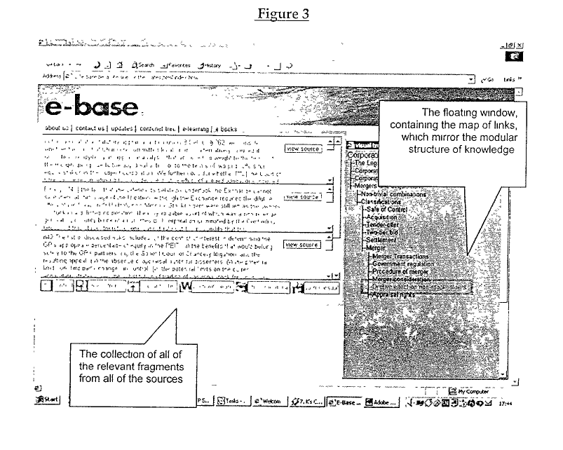

On the main screen, each node is accompanied by short outlines. The Outlines are usually a summary that is written by experts in higher and more general levels of the modular structure and later are taken from the content file as the paragraph that is highly representative of the node's idea. Outlines are used to guide the user in choosing the correct node in the following stage. FIG. 2 illustrates the structure and role of the outlines: Assume, for example, a layman seeks materials on a legal subject, in the field of corporate law. In following the map of links 20, the user will begin by double clicking the word “corporations” on the floating window. In reaction, the system introduces the four main subjects, or nodes, of corporate law. On the fixed window, the accompanying outlines 21 briefly explain the content of each subject. The outlines guide the user in choosing among the four nodes. By double clicking the desired node, s/he will proceed to the next stage on the knowledge tree, wherein more specified nodes are shown, with their accompanying outlines. In this manner, the system enables users who are not familiar with the professional terminology to get access to the relevant sources.

FIG. 3 describes the “guided tour”, or an example of a user navigation session, in which the user 31 navigates through various outlines 30, until arriving at the most relevant outline. Each outline contains basic paragraphs that describe the current node in which the user is stationed. The paragraphs describe each branch of the knowledge tree, so that the user can see what the various nodes are about, and thereby navigate to links that are connected or flow from the current node, according to the criterion of the user. This provides the user with a roadmap to know where to navigate. This tour enables the user to proceed from the initial node 32, which in the example is the general topic of “corporations”, to the following nodes 33, 36-39, until arriving at the desired content file. As the user reaches the desired node, he\she clicks a button that activates a content file on the specific idea that the node represents. The outlines are then replaced by a content-file, which provides the access to the relevant paragraphs in a multiple-windows window.

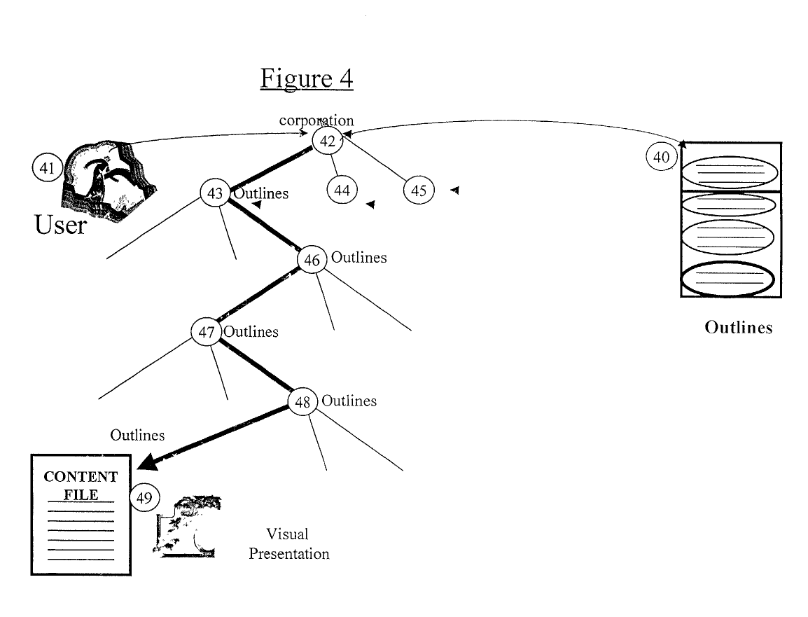

This window is an aggregated window, further subdivided into a plurality of separate windows, each able to be controlled by the user. This multiple-windows window can be seen in FIG. 4. The system of the present invention smartly integrates all of the relevant fragments of all relevant files that deal with the specified node and convey its meaning. In this way the user is able to simultaneously gain access to multiple highly relevant extracts. Every sub window in the content file reflects a paragraph that is tagged with a pointer from the original source. The paragraph conveys the node's idea. A link back to the “full text” source is assigned to every sub window. Furthermore every sub-window's title is a reference of the source file so that the user can easily cite it. Activating all the pointers that lead from a desired node to tagged paragraphs from relevant sources creates the content file.

The content file relies on pre-analysis of the texts—this means that every new source that is added to the content oriented database is first tagged with the ideas it conveys. Every one of the source's paragraphs is scanned for the ideas it conveys. The relevant paragraphs are then attached with pointers to the relevant node.

The content file is virtual—This means that when the content file is activated, all the pointers that currently lead from the node to the relevant paragraphs will be gathered in a multiple-windows window. The activation of the content file is therefore always updated with all the latest content that was added to the content sources.

There might be several content files associated with one node—For example within the legal field of knowledge there could be content files that deal with the law, codes and professional literature. In this way the same idea that is represented by one node could have several reference types. For instance the content file that deal with legislation allow the user to review all the relevant codes in one content file. Another example is in the case where the user wishes to read some professional literature on a particular professional idea. In this case, the user can click the “professional literature” button and scan a content file, which combines all the paragraphs that are taken from professional literature dealing with the same idea.

Internal windows enable the user to scroll up and down each specified paragraph, while an external window enables the user to scroll up and down the aggregate content file. The “view source” button enables one click access to the full text of each source file. FIG. 4 illustrates an example of such a situation, wherein three internal windows can be viewed in the large left hand block. The visual tree can be seen in the right hand block.

While source-files are organized according to their initial sources, content-files are organized according to content and meaning. Unlike current navigation and research systems, which encounter the user with source-files, the system of the present invention enables direct access to the content files, without requiring a prior viewing of the source file.

The content-file provides a powerful way of presenting concise content:

No need to engage in search—The modular structure of knowledge guides the user to the desired content file (using the outlines) in a way that:

The user does not have to master the relevant terminologies.

The user does not have to use Boolean logics.

The user does not get an overflow of search results.

The content file delivers in one aggregated file the end results of a research work. The paragraphs that users get in the content file reflect a comprehensive and concise knowledge about one professional idea within just a few clicks.

No need to engage in recurrent searches—Content files are always updated since they are virtually created upon the users request. This procedure ensures that at any given time when the user activates the content file, all the current assigned paragraphs are extracted automatically.

No need to engage in filtering—The content file automatically filters irrelevant paragraphs from the initial “full text”.

No need to engage in screening—The content file automatically screens out irrelevant textual sources.

No need to read all of the source-files: Since the content files only consists of paragraphs the user does not have to read through the full textual sources. The user may use the links from the paragraphs in the content file to the full textual sources to read the most useful sources (and not necessarily all of them).

Concise knowledge—The collection of carefully chosen paragraphs that light the same professional idea from many different angles, reflects concise knowledge.

Advantages of the singular screen—instead of opening many search sessions the content file delivers all relevant paragraphs from relevant textual sources within one editable file.

To further enable the user access to relevant pieces of information, there are buttons at the bottom of a content-file, which contain links to related materials, such as lectures, e-books, etc. These links are culled from supplementary data.

### The Guidance Method According to the Present Invention

The various capabilities of the present invention, as described above, can be implemented using the following method and components:

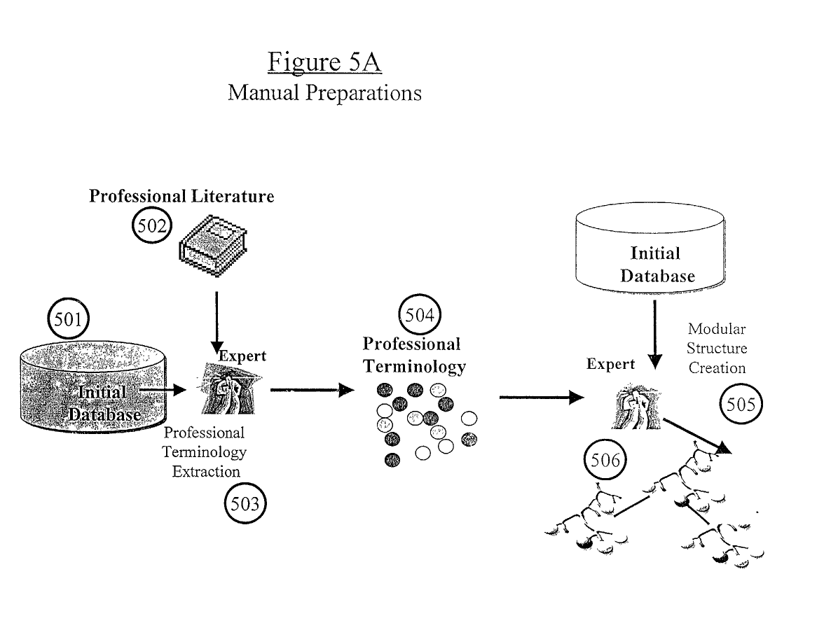

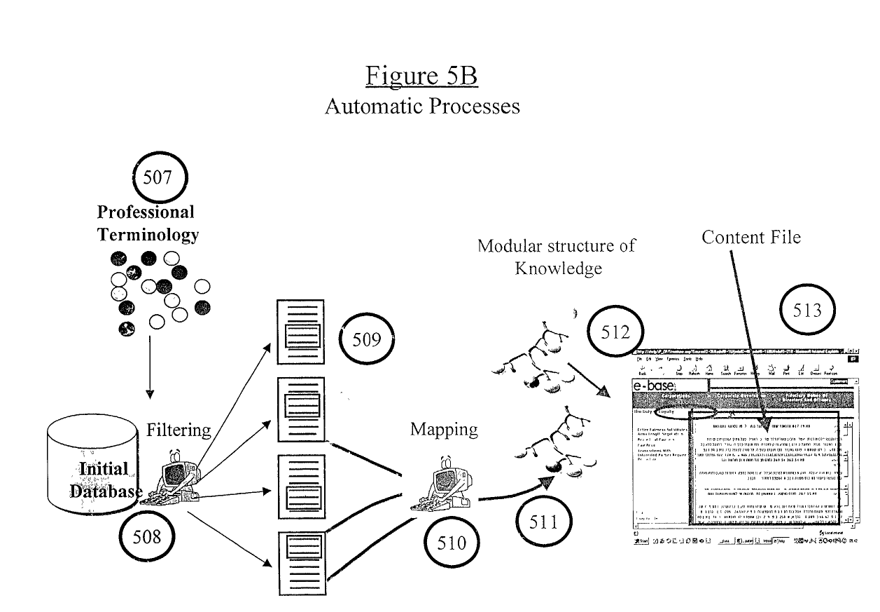

As can be seen in FIGS. 5a and 5b, the basic stages of the present invention are:

1. Providing an Initial database level 501, for storing the source content files that are relevant to at least one of the higher nodes, in a way that every paragraph attached to one of the lower nodes will be attached from this database. This will assure the specific content specific meaning and quality of the search results. It is from these files that the initial database, containing smart search results 501, is derived. For example, the present invention gathers relevant textual sources from dedicated databases, according to particular subjects as required. This process employs smart searches executed manually by experts. The number of searches is relatively small, as there are relatively few higher nodes. The higher node's structure follows the main classification of the commonly used professional literature 502. This procedure ensures that the upper structure is known and familiar to the user. This process also includes categorization of the data according to the primary levels of a knowledge tree.

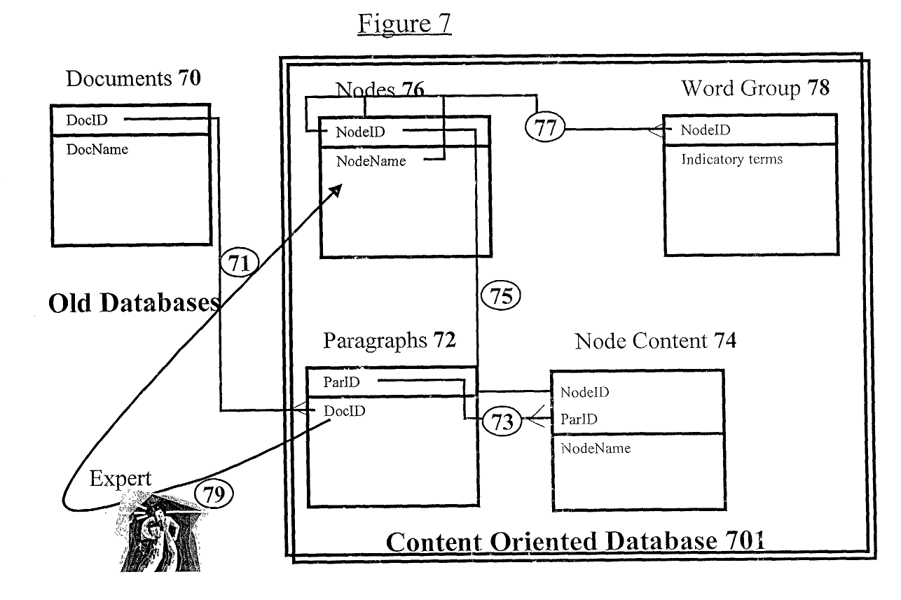

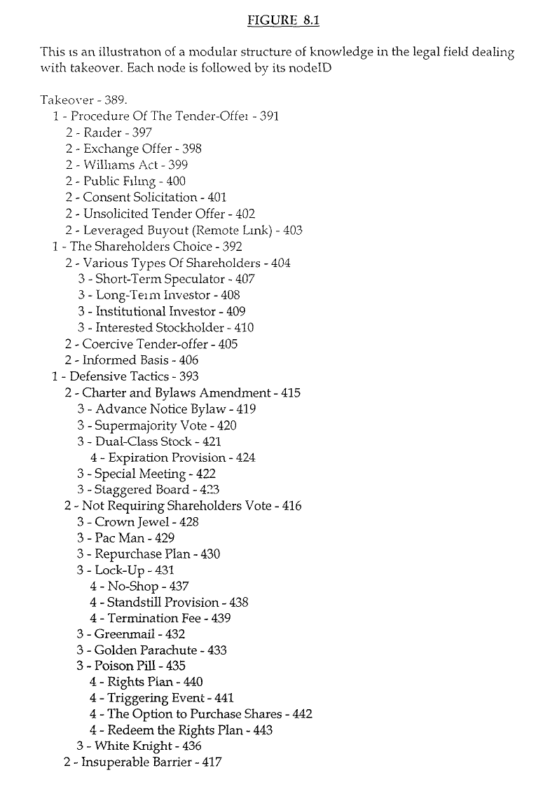

2. Compiling a collection of all the professional terminology in a content specific field of knowledge. This procedure is done by experts or non-experts that collect all the professional terminology that is relevant to every upper node 503. An expert in the content specific field supervises this procedure. The total sum of all the extracted words is equivalent to the complete professional corpus in a content specific environment. This professional terminology collection 504 is stored in a word groups table (78 in FIG. 7).

3. Modular Structure Creation 505. The experts goes back to the professional literature 502, and according to the order of appearance in these texts, constructs a modular structure of knowledge 506 for the particular subject being researched. This means, for example, that if identity term A proceeds term B in a sufficient number of times within the textual sources, it will be positioned above term B in the modular structure of knowledge. Furthermore groups of terms that convey the same professional meaning are grouped into Word groups and are allocated to the same node. The modular structure is built in a hierarchical way, such that every node has only one father. This process is based on the inner structure of texts, as determined by an expert, or as compiled automatically according to the inherent structure of language, as described below.

4. Filtering—The filtering procedure 508 is automatic and, as can be seen in FIG. 5B, relies on the professional terminology 507 as well as on the initial database 501. At the beginning of the process, each paragraph within every source is scanned by a filtering engine. The scanning procedure checks each paragraph for the existence of professional terminology within it. If the paragraph does not include any professional terms it will be filtered out of the system. This means that such a paragraph will remain in the initial database 501, alternatively referred to as the Documents table (70 in FIG. 7), where it will be untagged, and therefore no linked to any nodes or other tables. The paragraphs which have professional terms are tagged within the initial database 501, and the links to these paragraphs are stored in the paragraphs table 72. This paragraphs table 72 therefore does not store actual content from the source documents, but stores only links or pointers to the relevant paragraphs in the original source documents. The paragraphs table 72 is therefore extremely light and fast, and is able to instruct the content oriented database 701 to compile the relevant content on demand. The documents table 70 is equivalent to the initial database, storing the original full text documents for possible future reference. This ensures that the filtered out paragraphs are mapped by the system, even though logically they are not part of the knowledge tree and outlines. Other criterion may be used such as excluding paragraphs that are considered short (for example, if they are less than three lines long). The rational behind these rules is that if a paragraph is less than tree lines it is not likely that it will be able to convey a professional idea. Furthermore if the paragraph does not include any professional terms, it is again not likely to convey any professional idea.

Additional rules are included according to the professional field. For instance in the legal field, a paragraph that includes the $symbol will be filtered. In the legal domain the filter engine is designed to detect ruling and a $ symbol is a cue for a paragraph that deals with remedies. A tree dealing with remedies will not filter out such a paragraph. Only paragraphs that were not filtered in stage 509 continue to the next stage.

5. Mapping—Each paragraph that “survives” the filtering process is allocated to a relevant node according to the professional terminology 507 it includes. This means that if a paragraph includes a professional term that is taken from the word group of a certain node, it would be allocated to it by a mapping engine, in step 511. If a paragraph is suitable to two nodes that have the same father, it is an indication that the paragraph is more general and thus it is allocated to the father node. If a paragraph contains more than one term and is thus suitable to two or more nodes (that do not have the same father), the paragraph would be allocated to all the different nodes accordingly. If in the modular structure there exists two nodes (node A and node B) that have the same term within their word groups, a paragraph that includes this term would be assigned to the relevant node according to context. This is done by examining the source of the paragraph for indications of the existence of one of the fathers of the nodes. If the father of node A exists in the source, the paragraph would be assigned to node A, whereas if the father of node B appears in the text, the paragraph would be assigned to node B. If none of the fathers exists, the system will look for a grandfather etc.

6. Content files—Once the user has reached the desired node 512 a content file 513 can be activated. The content file 513 is the collection of all the paragraphs that were allocated to the node during the mapping phase. The content file 513, as described above, is a new mode of fragmental presentation, which enables the user to get acquainted with a variety of fragments that deal with the same professional idea. A link back to the source is attached to every paragraph. The paragraphs are organized in a format of a “multiple windows” window, which allows the user to navigate each paragraph separately, as can be seen in phase 513.

The method of creating the content files based on the modular structure of knowledge is a s follows:

1. From Initial Files to the Structure of Knowledge:

In order to enable the user immediate access to content-files, the system must substitute the initial data sources by a content-oriented database, where the allocation of texts to units is determined by content (e.g., shareholders' liability for corporate actions), and not by source (e.g., The Delaware Code). This means that every source is fragmented into paragraphs that convey meanings and ideas. Only those fragments that convey the ideas are mapped according to the suitable node in the modular structure of knowledge. Other paragraphs are not mapped. This method replaces the current system of classifying each “full text” with the relevant category such as topic, place of issuing, origin etc. However, the system must also preserve the initial allocation to source files, in order to enable users access to the “full-text” (i.e., the “view source” button).

The new platform of the present invention achieves these goals by splitting between the initial database 501, containing the full data sources, and a new, content oriented database, which is constructed from the set of links according to the modular structure of knowledge. This separation between the physical database (full text documents) 501 and the logical database (content oriented database) has the following advantages:

The content oriented database can be implemented on any given “full text” database and reorganize it according to the modular structure of knowledge. The only requirement is that the initial database contains files that deal with the content oriented field of knowledge.

The CPU time spent on searching using the content oriented database is minimal because the system only has to scan the word groups.

Every paragraph is contains an average of 2 k of information, so the time it takes to upload it is significantly shorter, compared to a full text that contains an average of 200 k of data.

The database is extremely light and therefore enables extremely quick retrieval of content files and search results.

Node-to-Node—Links that form the structure of knowledge by means of father and son (hierarchical) relations.

Node to Paragraphs—Links that lead from the node to the relevant paragraphs that deal with the node's idea.

Paragraph to Source—Links that link each paragraph to the initial source it was taken from.

Node to Word Group—Links that link every node to a group of words that convey the same meanings in other words or synonyms.

### Visual Presentations

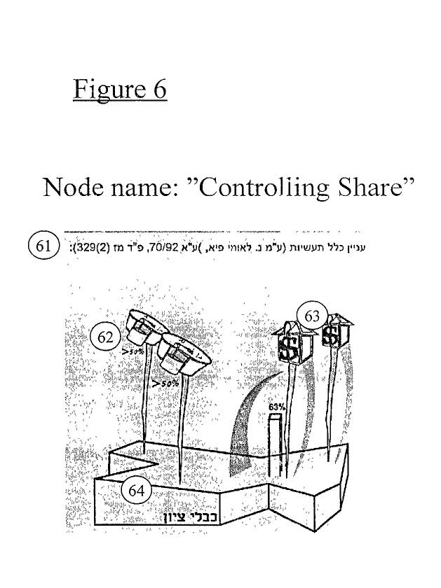

Finally, after having arrived at the chosen content file, the user can at this point gain access to an additional visual presentation that presents the desired idea, as can be seen in FIG. 6. The fixed window of the multiple-windows window screen may contain the visual presentations, which simulate and clarify the linguistic ideas. The visual presentations are static or dynamic illustrations that vividly convey the idea of the node. These visual presentations might include a specific use of the professional idea within the text or the general idea. FIG. 6 describes a professional idea from the legal field of knowledge in a specific environment. The visual presentation presents the legal idea of controlling shareowner. This is a template that will be later filled with data. At present this illustration can describe a legal situation. As can be seen in the figure, the presentation includes the name of the court opinion 61, the controlling share that are people 62, the controlling shares of institutions or organizations 63. Furthermore the company that is being dealt with is illustrated with reference to 64. This illustration can help the user understand the concepts that each full text describes.

FIG. 7 represents an example of tables that constitute the content oriented database of the present invention. According to FIG. 7, each rectangle represents a table within the new content oriented database. As can be seen in the figure, initial documents are stored within the document table 70. Every document is filtered in order to detect relevant paragraphs. These paragraphs contain parts of the original, or source, document and convey relevant content (depending on the field of knowledge). For example within the legal profession relevant paragraphs from court opinions would convey the ruling. These paragraphs are tagged 71 within the source file, stored in the documents table 70, and links to these tags are added to the paragraph table 72. The filtering procedure is described below.

The nodes table 76 contains all the ideas within a specific field of knowledge. The table represent a hierarchy of ideas where the initial node is the most general and is linked in a father-son relation to the sub ideas it conveys etc. Every node can be conveyed in a finite number of ways using a finite set of terminologies.

The Word Group table 78 attaches to every node (idea) all the relevant terminologies that can sum up to convey the same idea. The Word Group table 78 contains all the similar phrases or synonyms that are attached to the node. In this way, user searches may locate content files that were not directly searched for, based on similarity of context of the searched phase.

Every paragraph link from within the paragraph table 72 is mapped within the node content table 74 according to the meaning or meanings it conveys. The Node Content Table 74 therefore contains links to all the paragraphs that are attached to every node, using the Word Group table 78 in order to detect relevant terminologies within the paragraphs. If a paragraph reference from within the paragraph table 72 was not assigned to any node via the Content Node table 74, it is passed on to an expert 79. The expert will detect the idea that the paragraph conveys, that he/she will add the appropriate node to the Node table 76 with the appropriate synonyms or phrases to the Word Group table 78. This procedure will ensure that the next time a paragraph that conveys the same idea is added to the Paragraph table 72, it would find an appropriate node that represents its idea.

Any search for terms within the content oriented database does not include the documents table 70, but rather only the Word Group table 78, which contains all the terminology in a content specific field of knowledge. This procedure saves CPU time and allows the distinction of the different ideas that can be conveyed by the same terminology.

This combination of tables enables:

i. the connection of each source file to all of its paragraphs;

ii. the connection of each paragraph to at least one node;

iii. if a paragraph does not find any node that is suitable, it is transferred to an expert that would create a new node within the modular structure.

iv. the retrieval of the content file, such that if the user clicks on a node, this action activates all the paragraphs that are attached to it;

v. Each node is connected with a word group, which contains indicatory terms that convey the same idea, or are synonyms to the node;

vi. These connections of father and son create the modular structure of knowledge.

According to the structure of the above databases, while the initial database contains the full texts of initial sources, the new database is structured upon the set of links, and only contains pointers to the relevant paragraphs of the relevant files of each link. The pointers enable the system to undertake dynamic retrieval of fragments from the initial files, tailored according to the subject matter. The set of links reflects the structure of knowledge, and the pointers reflect the reorganization of initial texts in content-dependent units, wherein the retrieved fragments reflect the actual content. The set of links, together with the pointers and sets of fragments, form the content-oriented database.

2. The Database is Built of the Set of Links:

The current content-neutral databases make only a limited use of links and hyper-links, as the links are manually placed on the HTML (or other) files. This limited use of links results from the chronological precedence of texts to links: because texts have long preceded the various link-based technologies, the latter were added to the texts. However, this limited use of links does not have any logical rationale, nor does it fit a world of dynamically changing information sources, where existing texts swiftly become outdated as they are overtaken by newer works. Furthermore, as long as links are added to existing texts, currently available systems cannot achieve or trace any systematic phenomena within the texts. These systems cannot trace recurrence of similar links, nor construct any systematic structure of the links. Rather, both the use of the texts and the links themselves remain static and do not avail themselves to dynamic applications. Finally, the manual implementation of links also involves intensive labor and quality assurance work.

The Internet invites a reorganization of knowledge which puts the links ahead of the texts, such that the links would determine the access to the texts and not vice versa. The platform of the present invention makes this shift, and constructs its database on sets of links. As a set of links changes relatively slowly over time as compared to actual texts, the present system makes updating easier. Accordingly, new texts which enter a data source system are classified, sliced, patched, and linked to the relevant subject matters. This classification, filtering and mapping procedure entails automatic filtering of the initial document using the filtering engine. The fragments that “survived” the filtering are then mapped using the mapping engine on the modular structure according to their content by means of assigning pointers from the nodes to the relevant paragraphs, which it represents. This procedure is based on the modular structure, which conveys all the possible links. Relying on the assumption that knowledge rarely changes, most of the sliced paragraphs find their place according to their meaning onto the modular structure. Sometime a paragraph would convey more than one idea. In this situation it would be linked to more than one node. If the system was not able to find a suitable node for the paragraph, it means that there is a new node in the modular structure. The modular structure of knowledge would then be updated manually, by an expert, according to the nodes' context. Also, the present system is constructed upon the systematic structure of the links, as the set of links mirrors the modular structure of knowledge in each of the specified fields. The present platform enables dynamic retrieval of paragraphs referred to by the links, and thereby further enables the construction of novel combinations of the textual fragments into a content file. This means that all the paragraphs that are linked to a node can easily be retrieved following the users request. These fragments are taken form the initial texts “as is” and their collection within the content file can provide a comprehensive collection of references on a certain idea. The system can identify the relevant paragraphs by the pre-analysis that the textual sources have gone through upon their arrival to the system. Every new source is filtered by the filtering engine into relevant paragraphs that are automatically linked to the relevant nodes, allowing easy retrieval later on when the node is activated by the user. These fragments refer to actual content extracts taken from source texts. By analyzing and filtering these extracts, the system can pre-analyze the knowledge base, so that searches are not required to comb actual source documents but rather the content oriented database within the word group table. This procedure saves on CPU time as well and enables immediate retrieval. Finally, while the database is constructed upon the links, the latter are not apparent to the user, and therefore the desired outcomes are accomplished with no need for intensive labor or elaborate activities of quality assurance.

3. Pointers and Virtual Files:

To save system resources, the database of links does not include the texts, but rather, pointers to the relevant fragments in the initial database 501. A pointer is a link from the node to a relevant paragraph. Each node may have many pointers that are linked to several paragraphs. Furthermore there some paragraphs have several pointers from different nodes attached to them. Thus, when the user retrieves the content-file, s/he in fact retrieves a virtual file, containing various fragments of various files. The system can dynamically retrieve the relevant fragments due to the pointers.

4. Automated classification of source content

The following description enumerates the three fundamental elements of knowledge management, as defined by the present invention:

1. Construction of the modular structure of knowledge—The construction is a semi automated procedure wherein the computer traces the terminology and suggests a formation. The formation is based upon the inner structure of ideas in the texts, as will be described below. This way ensures that reappearing phenomena are captured, thereby achieving an objective and comprehensive formation of knowledge. A human expert then has to refine the initial structure according to context.

2. Filtering the initial files, such that only the relevant fragments are entered into the mapping system. Every field of knowledge is given different filtering rules according to the content specific needs and interests.

3. Tagging the initial files, to enable the linkages between every fragment and the relevant node on the modular structure of knowledge. The pointers then function in accordance with the tags. In a world where quantity of information is rapidly expanding, and knowledge sources are stored on databases that include thousands or even millions of references to long or short texts, it becomes unfeasible to manually trace and order the information by tagging and mapping. Tagging is the process whereby relevant paragraphs are automatically allocated to the relevant nodes within the modular structure of knowledge. This tagging is executed by the mapping engine, during the mapping process. Mapping is the process, whereby according to the allocations of each paragraph, a pointer is assigned from the node to the corresponding paragraph. This is achieved by searching for the word groups in the relevant texts. When found, it is assumed that these word groups reflect a particular subject or node. Rather, the practical feasibility of the process of knowledge management becomes contingent upon automation. Furthermore, the achievement of substantial improvements in searching accuracy and speed require the operation of such a system, that automatically filters, maps, and tags the relevant fragments.

However, in open texts, the wide variability in linguistic expression seems to preclude the possibility of deterministic machine-rules for filtering and tagging texts. Thus, it is at this stage that the salient contribution of the present invention is revealed, whereby the present novel system incorporates several enabling discoveries, which make both the automated filtering and the automated mapping possible.

### Enabling Discoveries

A comprehensive in-house linguistic research was conducted to promote the understanding of professional textual sources. The research was aimed at locating textual fragments that can be understood independently (without the surrounding context). It has become apparent that small portions of the paragraphs within a “full-text” source have an intriguing correlation with significant professional ideas. From that point on, the focus was to construct a method that would enable automatic identification and mapping of those paragraphs according to the ideas they convey. Such a method was developed using interdisciplinary expertise that relies heavily on mathematics (topology and group theory), computational linguistics (categorical grammar, Lexical-Semantic Relations), cognitive psychology (knowledge representation, semantic and neural networks), anthropology (grounded theory), and extensive experience in various professional databases. The present invention has been designed in order to enable the automated assignment of relevant paragraphs onto a modular structure of knowledge. The following discoveries unveil a linguistic breakthrough in the understanding of textual content and the different ideas they convey.

The Convergence of modular structure of knowledge with the Structure of Textual Expression:

In order to enable the automated mapping of textual fragments onto the nodes of the modular structure of knowledge, it was requisite to discover some “one-to-one” function that mirrors the correlation between the set of nodes on the modular structure and the set of textual fragments. This one-to-one correlation is a way of describing the necessary connections between nodes, such that each node can be traced historically to the most general node above it in just one path.

At this stage, two major enabling discoveries have been revealed:

1. Clusters of Meaning are accurate guidelines for the automated Mapping:

The present invention claims that every professional field consists of a finite number of “terms” or phrases that convey content specific meanings within the field of knowledge. Thus, if we construct the modular structure of knowledge upon these terms, such that each separate term forms a node on the modular structure of knowledge, then, the automated mapping can be guided by the rules governing the appearance of such terms within the texts.

The research revealed various kinds of terms:

A unique content specific meaning—In a content specific world there are a limited number of words that a professional community uses. These words enjoy a different meaning when used inside and outside of the professional contextual field. For example: the word “duty” has the everyday meaning of: “An act or a course of action that is required of one by position, social custom, law, or religion” On the other hand in the legal field “duty” is interpreted as “tasks, service, or functions that arise from one's position” or “an obligation assumed (as by contract) or imposed by law to conduct oneself in conformance with a certain standard or to act in a particular way”. The content specific terminology creates the initial bank of reference.

Types Of Terms:

Categorical Terms—These terms are abstract in their meaning. Every categorical term represents a different issue in the professional field. The total sum of these terms cover the whole filed of knowledge.

Textual Driven Terms—these terms form an elaboration for each of the categorical terms. The textual driven terms are extracted from the textual sources to ground the clusters of terms around every idea in the professional field.

A set of content driven synonyms: In order to locate the terms according to their meaning and group them into clusters, there is a need to identify similarity of meaning among the terms. Professional experts that have the ability to recognize the content-specific meaning of the terms and find different means to articulate them undertake this procedure. After the experts recognize the synonyms, the system creates word groups out of them. A label is assigned to every group, capturing the core idea it encompasses.

2. There Exists a Deterministic Structure in Textual Expression:

The remaining necessary condition for enabling the automated mapping of textual fragments on the modular structure of knowledge is the existence of some consistency in the appearance of clusters of meaning within the text. In other words, the research must trace the rules governing the usage of content-dependent terminology within the texts. Similar to the hierarchical structure of the modular structure of knowledge, the textual expression tends to proceed from the more general terms and ideas to the more specific and concrete ones. Accordingly, the more general term will always appear within the text before the more concrete and specific term is used. In other words, the modular structure of knowledge is grounded within the textual expression itself: in presenting some detailed idea, the author always begins by reference to the more general idea. Thus, the more general content-specific term will always appear in the text before the detailed ones. Subsequently, the various terms or ideas may be placed upon on each other, in order to represent repeating structures in a text. The sum of all these structures make up the modular structure of knowledge, which reflects the content specific knowledge. This modular structure is made up of two categories. The initial higher levels are those categorized by subject specific experts. The lower levels are those derived from the inner structure of the text, as described above.

Together, both of these discoveries imply the convergence between the modular structure of knowledge and the textual expression. Therefore a modular structure of knowledge can be constructed upon the analysis of a sample of texts, following which an automated mapping becomes feasible.

There exist Rules which Enable a filtering tool to distinguish between Relevant and Irrelevant Paragraphs

The purpose of the filtering tool of the present invention is to filter and thereby limit irrelevant paragraphs from textual sources. The relevance of the paragraphs is content dependent. This is done by allocating textual cues to a filtering algorithm. For every contextual field there exists different contextual cue. The filtering tool tags paragraphs that are not filtered out, from the documents table. These paragraphs are linked to a paragraph table, which is subsequently linked to a relevant nodes content table, according to the word groups of the node. The tables of the present invention contain links to relevant content, and not source data. This substantially speeds up searching and processing ability of the present invention.

Only after the filtering engine has removed the irrelevant paragraphs the system begins to check every paragraph. When a new relevant paragraph is detected, a new record is added to the “paragraph table” 72. If the paragraph already appears, it means that the system has already assigned the paragraph to some node and the paragraph conveys more than one idea. In this case the paragraph will be linked to more than one node. If the source from which the paragraph came from does not appear in the “source table” 70, a new source record is added to the “source table” 70.

This tool is implemented, according to the preferred embodiment of the present invention, by using Visual Basic Components that store the table in the MSSQL database.

There exist Rules which Enable the Automated Mapping of Textual Fragments on the Modular Structure of Knowledge, by a mapping tool

The purpose of the mapping tool of the present invention is to allocate paragraphs from the “paragraph table” to the modular structure of knowledge. This tool tags every paragraph with indicatory terms that identify several nodes of the modular structure by using several combining devices. A searching mechanism that has a few guiding rules for the identification of indicatory terms within the paragraph. The combination of these rules assures that the paragraph deals with the node's idea.

The tables that are used in this section are:

The paragraph table 72—as mentioned earlier.

The modular structure of knowledge table 76, or Node table—for every node there exists indicatory terms that convey the same idea. All these terms are enlisted in this table. The total sum of all the indicatory words from all the different nodes of the table gather up to the full corpus of the content specific field of knowledge.

An inter node container table 74, or Node Content table—This table captures for every node all the relevant paragraphs from the “paragraph table” that were found suitable. Therefore every new paragraph that is found as suitable for a specific node creates a new record for the node in the “inter node container” table.

The allocation procedure

This procedure is made up of two main functions:

Textual assignment—for every relevant paragraph from the “paragraph table”, the system of the present invention examines if one of the indicatory terms or a combination of indicatory terms appears in it. If so the “inter node container” table adds the paragraph to the appropriate node.

Double appearances—If two or more indicatory terms appear in one paragraph, a contextual algorithm attaches the correct contextual meaning to the paragraph and adds the paragraph to the appropriate node.

The invention claims that a paragraph that contains a “professional term” conveys the term's content specific meaning, unless certain contextual rules are found which might shift the linkage of the paragraph to a lower (son) node or an upper (parent) node.

The invention claims that “professional terms” indicate different levels of relevance and importance.

The invention claims that a paragraph that contains a “professional term's” inherits the term's level of relevance.

The invention claims that when two or more “professional terms” appear in one paragraph and convey different content specific meaning, the paragraph inherits all the different meanings.

The invention claims that when two or more “professional terms” appear in one paragraph and have different levels of relevance, the paragraph inherits the level of relevance according to the highest professional term.

The invention claims automated procedures that tag “relevant paragraphs” with the meaning they inherited from the “professional terms” that they contain.

The invention claims automated procedures that tag “relevant paragraphs” with the level of relevance they inherit from the “professional term” that they contain.

### Results

The discussion above reveals that the guiding vectors in linguistic expression, which make automation possible, are the clusters of meaning, as well as the tendency of authors to follow some specified rules in their usage. The present invention has shown that there is great benefit in retrieving the clusters of meaning from a wide enough sample of texts, and on identifying the specified rules that guide their usage. This has enabled the linkage between the appearance of clusters of meaning within fragments of texts and the modular structure of knowledge.

### Constructing the Modular Structure of Knowledge Upon the Enabling Discoveries

### Extracting Textual Driven Terms

Identification and Collection—The system retrieves suggested terms, which are subsequently verified by an expert, who then adds them to the word groups of every node. The collection of these terms is based on a pre-filtered selection of highly relevant textual sources. Only an expert is able to distinguish between the relevant terms and irrelevant words. This collection creates the initial lexicon of ideas in the specified field. The expert builds the higher levels of classification of a subject, according to commonly used literature. The more specific, or lower levels are constructed automatically by the system of the present invention, according to the enabling linguistic discoveries. The expert overseas and verifies these lower nodes.

Contextual Surrounding—The content driven synonyms are then retrieved, using real textual sources. The system suggests terms according to relevant collection of sources, which are verified by the expert, and subsequently placed in the word groups database. This procedure ensures that the word-sets are grounded in their content specific texts. The bondage is crucial because these minimal units will later serve the system as cues to retrieve information nuggets back from the text.

### Formation Of The Modular Structure of Knowledge

The Structure—The modular structure of knowledge is then constructed upon the clusters of meaning, as well as their use within the texts.

Features, Qualities and Capabilities

Depth v. Breadth—The basic guideline to construct the knowledge tree is to avoid unnecessary depth. This guideline allows the user to reach the most distant lexical term in the shortest number of clicks possible.

Links Organization—The modular structure is linked in a way that every lexical item has only one generalized term that encompasses it. This organization ensures that there is only one route leading from the most distant and specific lexical item to the most generalized one.

Expertise Representation—The choice of lexical terms and the their organization in the modular structure represents the whole field of knowledge and the expert's knowledge.

### The Central Components

### Content Editor Tool

The Content Editor is a tool, used by an expert 515, or some other person responsible for creating, defining and maintaining the structure and rules (content keys) used for the mapping/filtering of content files.

Content Editors are mostly professionals with extensive knowledge in their particular field of expertise (i.e. Corporate Law). They require an easy-to-use, easy to understand interface, in which to build and maintain the “knowledge trees”. This interface, or content editing tool, is currently created using ASP (active Server Pages) software and MS SQL Server 2000.

Within this environment, the Content Editor builds the hierarchical structure of the knowledge tree. He/she also assigns the mapping/filtering parameters, effectively giving meaning to a vast amount of data. The use of human content editors enables the preparation of highly professional content structures. A specific discipline would thereby require a basic initial infusion of an infrastructure for a specific body of content, by an editor. Following this initial stage, the content base for the specific discipline may expand infinitely with a negligible investment in re-editing, as it based on the initial programming.

The content editor uses a set of basic editing tools to construct the modular structure and to feed to the system all the indicatory terms. There are, however, preparations that take place before this procedure can take place. The first is the collection of all the indicatory words and their synonyms. A semi-automatic procedure arranges these terms onto a modular structure. This semi-automatic procedure includes the automatic detection of the relevant terminologies from a bank of relevant sources and their automatic arrangement according to semantic relations within a modular structure of knowledge. An expert then refines the structure according to context, classifying relevant nodes and word groups using the content editing tool. Professional dictionaries are inefficient since they do not convey all the possibilities that are used in the professional field. Relying on the sources themselves, only words that appear in texts are extracted. The system, therefore, scans new sources, and automatically looks for these terms when the commonly used terms are already detected.

Furthermore the system can detect new terms that were not used before. This is done using the combination of the filtering and mapping engines in the following way. If a paragraph that was not filtered is a relevant paragraph. This paragraph has to be allocated to a node on the modular structure of knowledge according to the indicatory words that it contains. If the mapping engine was not able to allocate the paragraph to the modular structure it means that there is a new term hiding within it. The paragraph is transferred to an expert, which according to its context, can add a node to the tree with the new indicatory term that was not detected by the system. This can assure that the next time a paragraph containing the new term is mapped the system will be able to allocate it properly automatically.

### Filtering Engine

This component is a software means, currently created using Perl, XML, an algorithm language, ASP, SQL, and Visual Basic software, wherein Visual Basic Components store tables in the MS-SQL database.

The purpose of the filtering tool is to filter out irrelevant paragraphs from textual sources. The relevance of the paragraphs is content dependent. This is achieved by allocating textual cues to a filtering algorithm. For every contextual field there exist different contextual cues. The filtering algorithm relies on the linguistic expert to extract those rules according to a collection of representative sample of relevant sources within the specific field of knowledge. The filtering tool uses two main tables, a “source table” and a “paragraph table”. Where the paragraphs in the “paragraph table” are taken from a “full text” source in the source Table.

When a new relevant paragraph is detected, a new record is added to the “paragraph table”

If the source from which the paragraph came from does not appear in the “source table”, a new source record is added to the “source table”

### Mapping Engine

This is created using Perl, XML, algorithm language, ASP, SQL, and Visual Basic software. The Mapping Engine applies the content keys assigned by the Content Editor and performs mapping of the text objects (Word, Excel, HTML, raster files, PDF, etc.) in a File Bank. A file bank is a collection of tagged sources that have gone through the filtering process. These tagged paragraphs are later assigned to the relevant node. Content Keys are a new technological concept which utilize mapping algorithms. These algorithms are based on the mathematical set theory (for example, hierarchical father/son relationship, property inheritance, etc.).

The purpose of the mapping tool is to allocate paragraphs from the “paragraph table” to the modular structure of knowledge. This tool tags every paragraph with indicatory terms that identify several nodes of the modular structure, by using several combined devices.

The tables that are used in this section are:

The paragraph table 72—as illustrated in FIG. 7, and described above.

The Nodes Table 76, as illustrated in FIG. 7. For every node there exists indicatory terms that convey the same idea. All these terms are enlisted in this table. The total sum of all the indicatory words from all the different nodes of the table gather up to the full corpus of the content specific field of knowledge.

The Node Content Table 74, as illustrated in FIG. 7. This table captures for every node all the relevant paragraphs from the “paragraph table” 72 that were found suitable. Therefore every new paragraph that is found as suitable for a specific node creates a new record for the node in the Node Content Table 74.

### The Allocation Procedure

This procedure is made up of two main functions:

Textual assignment—for every relevant paragraph from the “paragraph table” 72, the system examines if one of the indicatory terms or a combination of indicatory terms appear in it. If so the “inter node container” table 74 adds the paragraph to the appropriate node.

Double appearances—If two or more indicatory terms appear in one paragraph a contextual algorithm attaches the correct contextual meaning to the paragraph and adds it to the appropriate node.

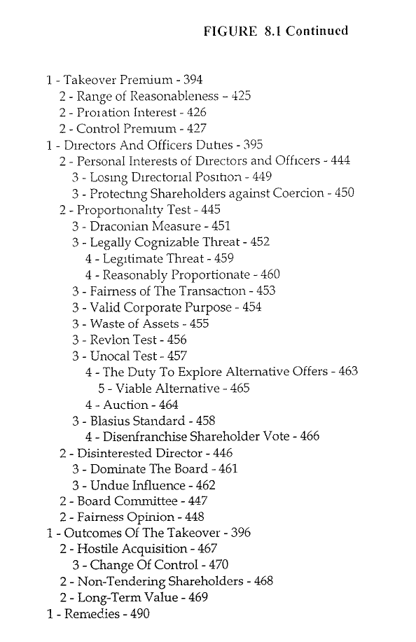

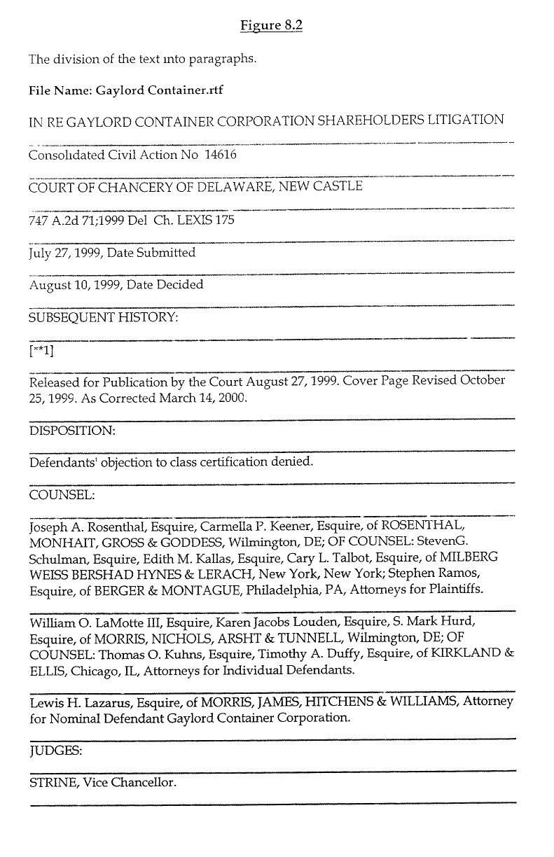

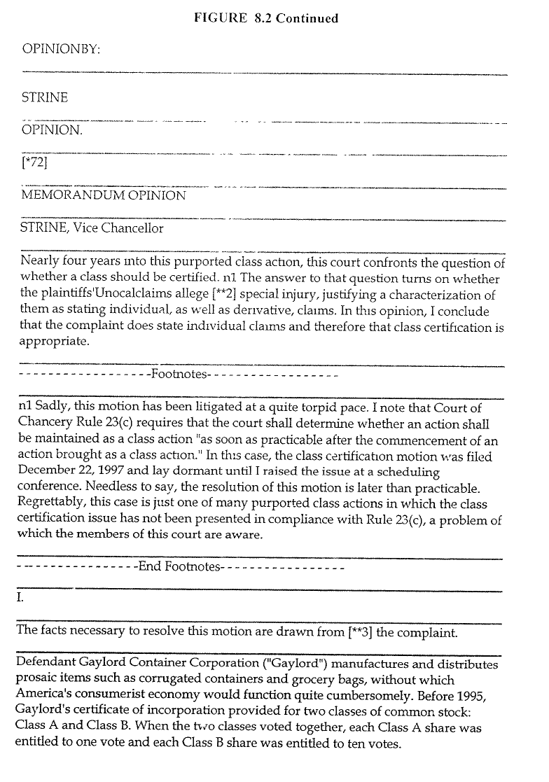

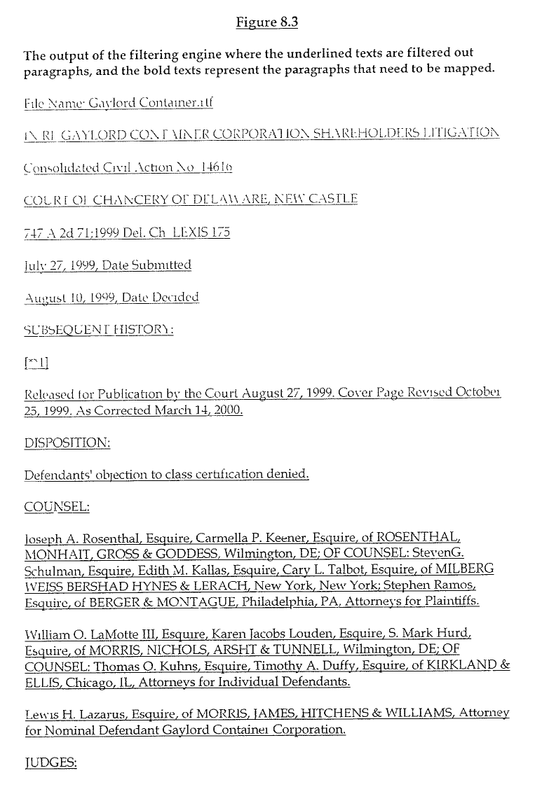

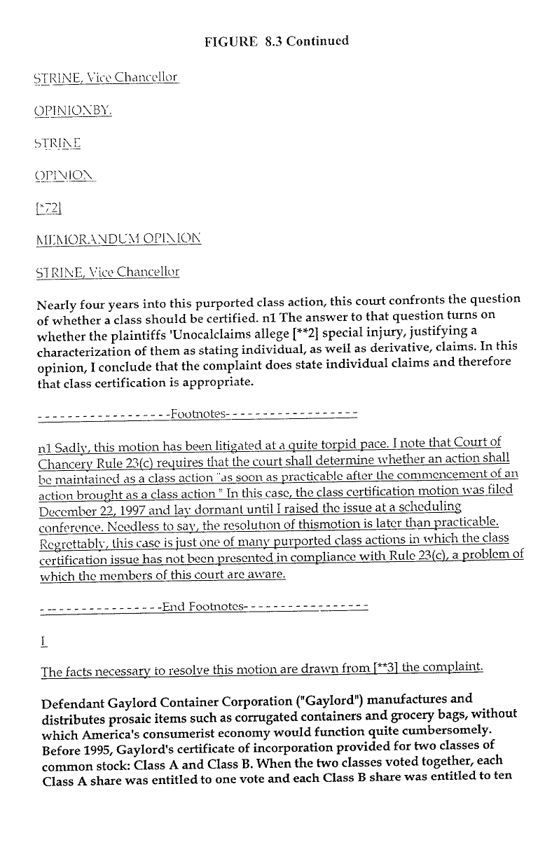

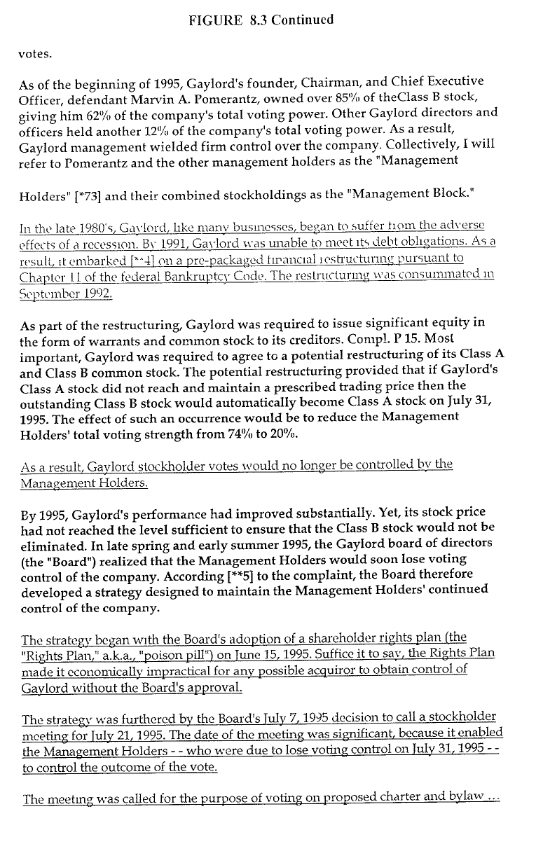

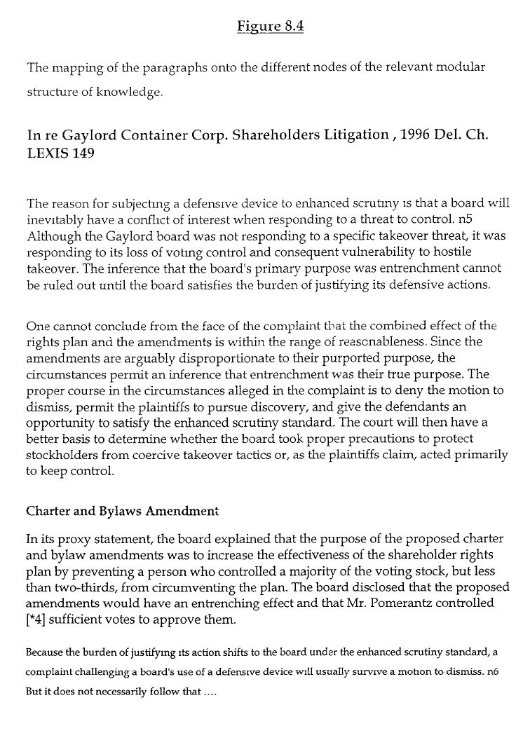

FIGS. 8.1-8.4 illustrate the 4 stages of system analysis. In FIG. 8.1, an illustration is provided of a modular structure of knowledge in the legal field dealing with takeover. Each node is followed by its nodelD. The figure represents just a segment from the whole modular structure in corporate law. The categorization into nodes is automatically constructed upon a sample of highly relevant textual sourced dealing with takeover, in this case. An expert later refines the construction.

FIG. 8.2 provides a segment of an example illustrating the division of a single source into paragraphs. As can be seen, each paragraph, or section of the text that is separated by at least a tab, is placed on its own and defined as a paragraph.

FIG. 8.3 illustrates a section from the output of the filtering engine, whereby the original text is divided up into those texts that are filtered out, and those that must be mapped. In the figure, the underlined texts are to be filtered out are bold texts represent the paragraphs that need to be mapped.

FIG. 8.4 illustrates the mapping of the paragraphs onto the different nodes of the relevant modular structure of knowledge. As can be seen in the figure, all the nodes that appeared in the text are presented as titles. Following the node name, all the paragraphs from the sample sources that deal with the specified idea are accumulated. This provides a collection of the ideas that were conveyed in the sample text and the paragraphs that were automatically detected by the system and assigned to them.

As has been described above, the best mode of the present invention is the development and usage of a knowledge management tool for a specialized field of knowledge, such as the legal profession. Such a tool provides substantially improved accuracy and efficiency in conducting online research, and subsequently managing the research.

An additional embodiment of the present invention enables integration of the present invention within old information searching formats. According to this embodiment, the user may gain access to the content-files through a conventional smart search engine. In this scenario, the user enters the subject matter which she is searching for into the search box and clicks “search”. The system recognizes the relevant node on the knowledge tree, and instantly directs the user to the relevant content file. In this manner, the user can get enjoy the “brain” of the system, as well as the advantages of content-files with no need to “follow the map of links.”

According to a further preferred embodiment of the present invention, a solution is provided for professional researchers, such as legal firms performing legal research. At present, the research is done by assistants, who must go through the following procedure:

Defining the legal issue or the legal question.

Reading through professional Books.

Searching on CD and other offline databases.

Using costly online professional services such as LEXIS and WESTLAW.

Cutting and pasting work, in order to transfer the relevant citations from their initial files to the concrete legal opinion.

Forming a draft of a legal opinion for a senior lawyer.

This process is costly and time consuming, both for the law firm and for the client. In contrast to this, the present invention provides professional users with a research system where:

The modular structure of knowledge guides the user to the relevant paragraphs of the relevant files within just a few “clicks”. The research results will become available with no need to engage in any costly and time-consuming search processes.

The system provides an effective solution to the overflow of information, whereby the user can achieve superior results even to those of an experienced professional expert.

The billing system attunes the fees to each “tour” on the modular structure, such that the professional pays “per-use”.

The system offers an innovative way to capture the expertise of the professional. This is achieved by the inspection of the terminology and the modular structure of knowledge. This inspection enables even the average user to enjoy superior results.

A further embodiment of the present invention is an application for content providers. Content is traditionally compiled manually, which is generally requires a significant quantity of workers. In prior art content provider systems, as information doubles in shorter time frames, the manual method is becoming increasingly impractical. In addition, the “cheap” personnel who are hired are generally not capable of dealing effectively with the overflow of information, and inevitably results in lower standards of content. In contrast to this, the present embodiment of the present invention includes the following innovative aspects:

Automated content aggregation—the present invention acquires all the relevant textual sources needed for each topic using advanced searches.

Automated textual fragmentation—Each textual item is sliced into atomic units of ideas. All of the ideas together cover the whole domain.

Automated ideas organization—The ideas are organized in the professional site, making all the information accessible within just a few clicks.

A further embodiment of the present invention is an application for enterprise information portals, wherein the proliferation of interest in “knowledge management” in the last few years is a reflection that information has finally gained visibility as a major corporate asset. Furthermore, sharing information across the organization and between organizations to support greater learning and competitiveness, has resulted in moving to the next level of information management (IM)—knowledge management. It is estimated that enterprises, using prior art knowledge management systems, loose billions of dollars a year because of inefficiencies resulting from intellectual rework, substandard performance and an inability to find knowledge resources. This is expected to become substantially more acute. There is further evidence that there is an ineffective deployment of knowledge resources, a huge quality of wasted research time, and a clear admission that enterprises cannot possibly survey all the relevant information every day.

In contrast to this, the current embodiment of the present invention provides: An automated method to track and file personal and public content into one integrated knowledge base; automated tools to organize the enterprise's knowledge in a modular structure; and a personalized enterprise's portal that replaces the worker's desktop, and allows access to the enterprise and personal knowledge, online and offline.

### Advantages of the Present Invention

The system enhances knowledge acquisition in several ways:

1. An effective solution to the overflow of information: As the system guides the user to the relevant pieces of information, the user no longer faces an overflow of information.

2. A smart process of uploading sources onto databases: the present invention shifts the process of uploading sources on the computer, from a source-based upload to a content-based upload. When a file is uploaded on the system of the present invention, its paragraphs are automatically linked to the relevant content-files.

3. Smart tools: the present invention substitutes the Boolean search engines by smart tools for filtering and mapping the sources. The smart tools dramatically reduce the amounts of information, and resolve the problems of content neutral search tools.

4. An “automated duplication” of expert-searches: Because the mapping process is attuned to the modular structure of knowledge, and because the modular structures are constructed by content experts, the system of the present invention enables the automated duplication of expert searches.

5. An “automated save” of past searches: The present invention filters and organizes the sources, before the knowledge is introduced to the users. Thus, once the system completes its filtering and mapping, the outcomes are automatically saved for users.

6. An “automated update”: New materials are immediately linked to the relevant content files, when they are uploaded on the system of the present invention. Accordingly, the content files are continuously updated.

7. A new concept of integration: The present invention integrates the organization of databases with the knowledge tree, the user's interface, and the user's workplace. Accordingly, all sources are automatically organized within a synchronized structure without burdening the user.

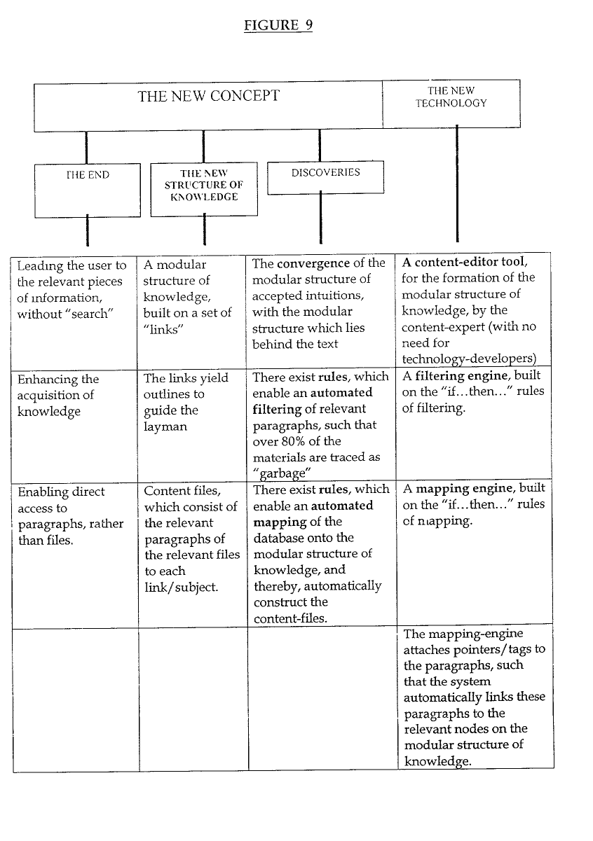

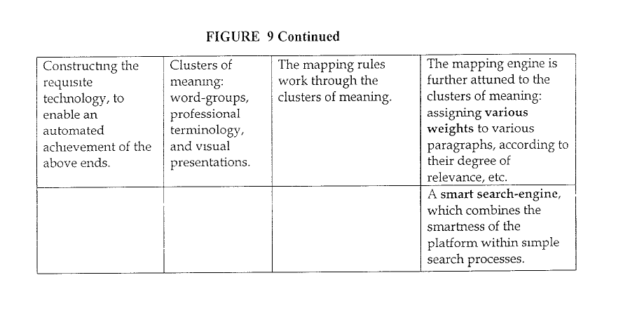

FIG. 9 illustrates the novel elements in the platform of the present invention.

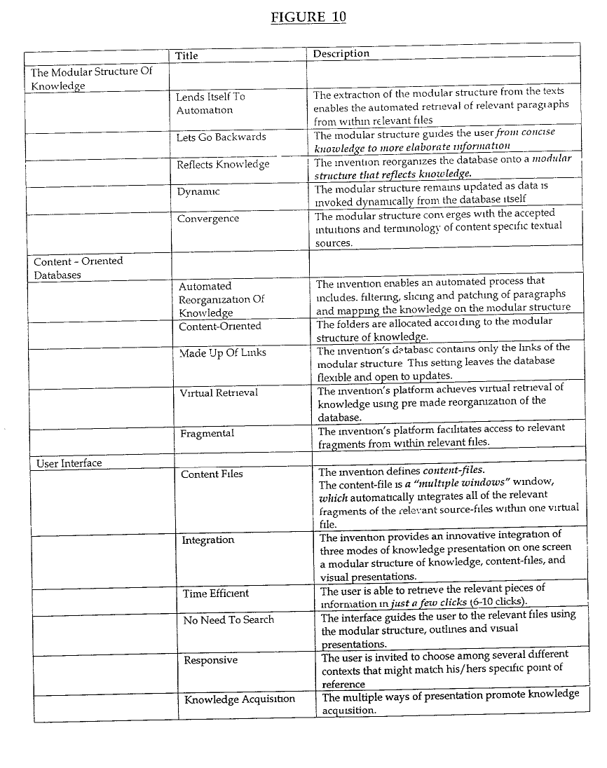

FIG. 10 is a table summarizing the novelty in each of the new system's elements.

The foregoing description of the embodiments of the invention has been presented for the purposes of illustration and description. It is not intended to be exhaustive or to limit the invention to the precise form disclosed. It should be appreciated that many modifications and variations are possible in light of the above teaching. It is intended that the scope of the invention be limited not by this detailed description, but rather by the claims appended hereto.

What is claimed is:

1. A system for managing knowledge acquisition from electronic databases, comprising:
i. a filtering engine for analyzing smart search results, such that relevant information fragments are tagged according to professional terminology and content specific cues;
ii. a mapping engine for allocating said relevant information fragments, provided by said filtering engine, to knowledge nodes, thereby enabling the virtual creation of content files; and
iii. a content editing tool for enabling a human content editor to create a database of said smart search results, and categorizing unmapped said information fragments on said knowledge nodes, such that a modular structure of knowledge is formed;
iv. a content oriented database system for storing said content files, said database of smart search results, a database of pointers to paragraphs, a database of said modular structure of knowledge, and an hierarchy of professional terminologies according to word groups in a specific field of knowledge; and
v. a user interface for enabling user interaction with said content oriented database system, such that said user can navigate within said modular structure using outlines.

2. The system of claim 1, further comprising a processing means for executing pre-analysis of texts by said filtering engine and said mapping engine.

3. The system of claim 1, further comprising a server system for serving said content files to users.

4. The system of claim 1, wherein said filtering engine redefines knowledge according to information fragments, according to the following steps:
a. automatically breaking up information sources into paragraph form, representing fragments of knowledge;
b. filtering said paragraphs in order to identify relevant paragraphs; and are
c. tagging said relevant paragraphs to said modular structure of knowledge, using professional terms.

5. The system of claim 4, wherein said information fragments are categorized according to a modular structure that represents knowledge, such that each said fragment is linked to at least one node of said modular structure, such that the sum of all the nodes convey the ideas in a content specific field of knowledge.

6. The system of claim 1, wherein said mapping engine allocates said relevant information fragments to said knowledge nodes, according to the following steps:
(i) locating paragraphs that remain after said filtering process, and tagging said paragraphs according to professional terminologies;
(ii) allocating each said paragraph to at least one relevant node according to a word group table;
(iii) in case of two identical nodes that match a same said terminology, allocating said paragraph to at least one relevant node using said paragraph environment and linking said node to an original source;
(iv) identifying paragraphs that were not mapped, and extracting new terminologies that said paragraphs convey; and
(v) creating new nodes within said modular structure of knowledge, according to said new terminology.

7. The system of claim 1, wherein said content files are displayed on an output device in a multiple windows window.

8. The system of claim 7, wherein said multiple windows window represents a virtual file, such that each said window in said multiple window can be operated independently, and such that each said window represents one paragraph that conveys said node's idea and a link back to original information source of said node.

9. The system of claim 1, wherein said client application is a personalized knowledge portal that replaces a user's desktop, and allows online and offline access to at least one knowledge base, according to the following steps:
i) allowing the user to create modular structure of knowledge, inclusive of personal terms, synonyms and hierarchy;
ii) allocating a personal content oriented database to store said modular structure of knowledge and information sources;
iii) enabling the user to view personal content files from said personal content oriented database; and
iv) enabling the user to compose explanatory outlines.

10. The content oriented database of claim 1, further comprising:
I. an initial document table, that includes sources from a specific professional field of knowledge;
II. a paragraph table that includes pointers to tagged paragraphs within said document table;
III. a nodes table that includes a variety of ideas in a content specific field of knowledge, such that said ideas are arranged from more general ideas on the top nodes to very specific node on the bottom nodes, using hierarchical relations;
IV. a word group table that includes a collection of professional terms that define every idea within said node table; and
V. a node content table that includes pointers from every idea within said node table to all relevant paragraph within said paragraph table, using relevant word groups within aid word group table.

11. A method for categorizing information online, based on the inner structure of texts, comprising the steps of:
i. identifying keywords that are related to a content specific field of knowledge;
ii. enhancing each said keyword with alternative terms for conveying said keyword's idea; and
iii. placing said terms within a table system that assigns every node which conveys a professional idea to a table of word groups, such that a table of paragraphs is allocated to each said professional idea.

12. The method of claim 11, wherein said inner structure of texts is derived according to the following steps:
a. creating a collection of sources that deal with a content specific field of knowledge. b. extracting professional terminology from said collection;
c. clustering extracted said professional terms into clusters of meanings in a node table;
d. defining resulting clusters into word groups, which are placed in a word groups table, for enabling matching of said word groups to said nodes during user searches;
e. organizing a hierarchical relationship in said node table, according to the order of appearance of said terminology in said texts;
f. providing a processor with filtering software, coupled to said paragraph table, for filtering relevant information fragments in said paragraph table;
g. providing mapping software for allocating said relevant fragments to at least one node in a node table, such that every paragraph is linked to said node table; and
h. in the cases where said fragments cannot be assigned to said node table, sending said fragments to an expert, to define a new node and said new node's position in said node table.

13. The method of claim 12, further comprising a response to a user search request, comprising the following steps:
A) recording the search request by an application program of the user, such that the search is chosen by the user by operating an input device coupled to a processor;
B) requesting by said processor of a database for said terminology within a word group table;
C) if said terminology is found, presenting the user with relevant nodes within said node table that match the desired request;
D) presenting the user with paths of the said modular structure of knowledge that lead to said node in said node table;
E) if one of the nodes that was presented was selected from a relevant outline, displaying content file and visual presentation of said node on a user output device;
F) if said search phrase is unavailable, searching an original content database for said search request, by said processor; and
G) accumulating and analyzing unavailable terms, by an expert, such that said expert adds said new node in said node table, and such that said expert adds relevant terminologies in said word group table.

14. The method of claim 13, wherein said search request includes a search for a word group using an existing search mechanism, such that said search request is responded to by providing a content file linked to said word group.

15. A method of filtering textual data into a modular structure of knowledge, comprising the steps of:
i. defining professional ideas in a specific field of knowledge;
ii. collecting all relevant terminologies to define said ideas in word groups;
iii. if said word group combinations do not appear within a paragraph, filtering out said paragraph;
iv. if said word group combination appears within a paragraph, tagging said paragraph to a relevant node in a node table to which said word groups belong;
v. if content specific cues appear within a paragraph, filtering out said cues;
vi. tagging paragraphs that remain after said filtering procedure, such that said paragraphs are linked to nodes within a modular structure of knowledge; and
vii. activating paragraphs that are linked to a same node in said node table via said node content table, within a content file, when the user navigates to said node.

16. A method for tracking and filing personal and public content into one integrated knowledge base, such that users can save and share knowledge searches, comprising the steps of:
i. defining ideas within a personal modular structure of knowledge in a node table;
ii. allocating word groups that define ideas using alternative terminologies in a word group table;
iii. organizing said ideas using a hierarchical relationship within said node table;
iv. collecting a database of sources that deal with a personal topic of interest in said document table; and
v. employing a modular structure of knowledge to a personal database, such that said user creates a personalized paragraph table and a personalized node content table.

17. An engine for searching pre-analyzed content files, such that search queries are executed on the content files, providing highly accurate results in an accelerated time-frame, comprising:
i. a database system for storing documents in their original format;
ii. a content oriented database for storing links to fragments of said documents, such that said fragments are filtered and mapped onto a modular structure of knowledge;
iii. a user interface for enabling user interaction with the said database system;
iv. a server system for processing queries from said user interface, and serving the results of said queries to users;
v. a software application that supports the dynamic and virtual retrieval of content files.

18. The engine of claim 17, wherein said database system comprises:
a) initial database level for storing original content from information sources;
b) a processor for filtering and mapping said original content into content fragments; and
c) a table system for storing said links to content fragments processed by said processor, such that said table system contains pointers to said content fragments and said original content.

19. The engine of claim 18, wherein said processor automates filtering and mapping of said content fragments on a pre-configured modular structure.

20. The engine of claim 18, wherein said table system stores links to information fragments, thereby enabling accelerated searching.

21. A method of automatically defining a body of knowledge, comprising the steps of:
i. defining professional terms that convey content specific ideas;
ii. defining alternative expressions that convey said professional ideas;
iii. dividing said body of knowledge into information fragments;
iv. filtering said information fragments according to usage of said professional terms;
v. tagging every information fragment that contains said professional terms, such that said paragraph inherits said professional term's identity;
vi. when two or more professional terms appear in one paragraph and convey different content specific meaning, providing said paragraph with all said different meanings, such that more than one professional idea in said node table will be assigned to said paragraph.
vii. when two or more “professional terms” appear in one information fragment and have different levels of relevance, providing said information fragments with the level of relevance according to the highest rated professional term within the modular structure of knowledge;
viii. tagging relevant information fragments with the meaning they inherited from the professional terms that they contain; and
ix. tagging said relevant paragraphs with the level of relevance they inherit from the professional term that they contain.

22. The method of claim 20, wherein said engine enables billing per use, according to the following steps:
a) monitoring each user request according to personal user access data;
b) recording each tour of said user, such that fees are charged for each said tour within the modular structure;
c) enabling a content provider to bill said user according to specific nodes that were clicked by said user;
d) enabling said content provider to bill according to content files that have been used; and
e) enabling said content provider to bill according to time spent within every node of the modular structure of knowledge.
